(19) United States
(12) Patent Application Publication
(10) Pub. No.: US 2008/0082949 A1
(43) Pub. Date: Apr. 3, 2008

(54) Method, Apparatus and Media for Updating CAD Data with Printed Circuit Board Stencil Data

(75) Inventors: Alec Schwartz, Round Rock, TX (US); Ron Sparks, Austin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/537,651

(22) Filed: Oct. 1, 2006

(51) Int. Cl. G06F 17/50

(52) U.S. Cl. 716/15; 716/2

(57) ABSTRACT

A method of updating electronic data utilized in the making of a printed circuit board assembly, which may include the steps of determining whether the board meets qualification standards and updating the electronic data based on the qualification standards to optimize the manufacture of the printed circuit board,

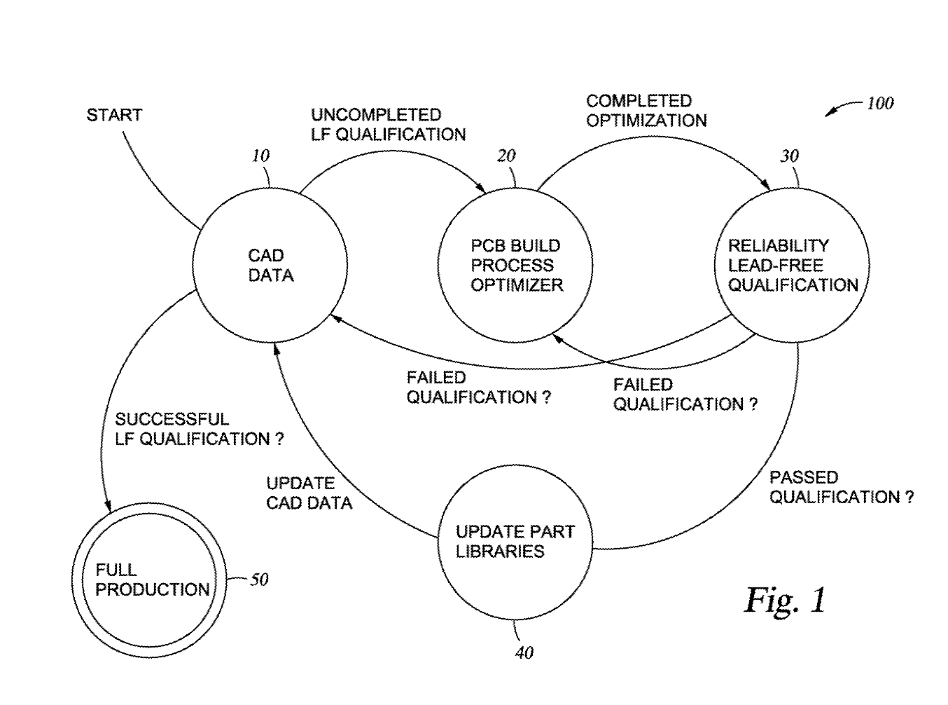

### BACKGROUND

1. Technical Field

The present disclosure relates generally to information handling systems, and, more particularly to circuit boards.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Solder is utilized in the manufacture of printed circuit boards. While lead-free solder introduces more quality issues into the manufacture of printed circuit board assemblies, there is currently a push toward use of lead-free solder.

The push is being lead by the European perspective on waste management and recycling as described in the European Union's Waste of Electrical and Electronic Equipment and Restriction of Hazardous Substances, which strongly suggests that lead-free electronic assemblies will be mandatory in Europe by 2008. Likewise, Japan has moved toward voluntary compliance with a lead-free initiative that focuses on environmental marketing of new products such as mobile phones, consumer electronics and automotive electronics (with the exception of recycled lead-acid storage batteries). The viewpoint concerning lead-free electronic assemblies in the U.S. is somewhat different since lead usage in electronic solder comprises less than 1.0% of total lead consumption. However, every year in the U.S., technological obsolescence of end-of-life (EOL) electronic products results in tens of millions of used computers being dumped as solid-waste.

Unfortunately, as compared to leaded-solder, lead-free solder has poor flow characteristics and thus induces more quality issues into the PCB solder print process than leaded-solder.

### SUMMARY

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided a method of updating electronic data utilized in the manufacture of a printed circuit board assembly. The method includes determining whether the board meets qualification standards. The method also includes updating the electronic data based on the qualification standards to optimize the manufacture of the printed circuit board.

According to another non-limiting embodiment there is provided a method of qualifying a printed circuit board assembly. The method includes of manufacturing a printed circuit board assembly utilizing electronic data. The method also includes determining whether the assembly meets qualification standards. The method even also includes updating the electronic data based on the qualification standards to optimize the manufacture of the assembly. The method still also includes manufacturing a subsequent assembly utilizing the updated data. The method yet also includes iterating the above determining, updating and manufacturing (the subsequent assembly) steps in sequence, until the subsequent assembly meets qualification standards.

According to another embodiment there is provided an a computer readable medium having stored thereon a data structure comprising electronic data obtained from a printed circuit board qualification process, the printed circuit board comprising a number of components of interest, the data structure operable as a computer aided design file for use in the manufacture of subsequent printed circuit boards. The data structure includes a component data field for each component of interest comprising data identifying that component. Further, there is associated with associated with each component data field at least one of the following data fields: a first data field comprising solder stencil geometry data; a second data field comprising preheat temperature data; a third data field comprising preheat time data; a fourth data field comprising time above liquidous (TAL) data; a fifth data field comprising peak temperature data; a sixth data field comprising pre-heat rising ramp rate data; a seventh data field comprising TAL rising ramp rate data; an eighth data field comprising TAL falling temperature ramp rate data; a ninth data field comprising moisture sensitivity level; a tenth data field comprising heat resistance; a eleventh data field comprising solder paste composition; and a twelfth data field comprising PCB surface finish.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

The drawing is a schematic showing a non-limiting embodiment for the back annotation of solder paste stencils and/or temperature profile data into electronic computer aided design (CAD) files, as it relates to the making of printed circuit board assemblies (PCBA).

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

Referring now to the figure there is shown a non-limiting embodiment for the updating of electronic data as this data relates to the making of printed circuit board assemblies (PCBA). Such data may be configured in computer aided design (CAD) files 10 and Part Libraries 40. Non-limiting examples of data which may be updated includes solder paste stencil data and/or temperature profile data.

Where components are to be placed, the printed circuit board has flat, usually tin-lead, silver or gold plated copper pads without holes, called solder pads. Solder paste, a sticky mixture of flux and tiny solder particles, is first applied to all the solder pads with a stainless steel stencil.

CAD data 10 may include data that is utilized in the building of the printed circuit boards, and may include data of interest to the user. Certainly, what this data comprises may vary from user to user, and perhaps may even be product or product application specific. As a non-limiting example, such CAD data may include at least one of solder stencil geometry data, preheat temperature data, preheat time data, time above liquidous (TAL) data, peak temperature data, pre-heat rising ramp rate data, TAL rising ramp rate data, TAL failing temperature ramp rate data, component moisture sensitivity level (MSL), heat resistance (HR), solder paste composition, and the PCB surface finish. MSL and HR data provide the susceptibility level beyond which the components maybe damaged. Having MSL and HR data integrated into the CAD data will allow for automated checking against the manufacturing process and prevent excursions beyond the limits.

In PCB build process 20, solder paste is printed onto the printed circuit board using a solder paste stencil. In the making of printed circuit boards, the main reason for printing solder paste onto the PCB is to supply solder alloy for the solder joints where surface mounted devices (SMD) will be attached. In the practice of embodiments of this disclosure, any number of methods and apparatus may be used to print solder paste onto printed circuit boards. As a non-limiting example, quality and price issues make laser-cut stainless steel stencils a popular alternative. As another non-limiting example, mesh screen-printing may be used was used except for fine pitch and small chips.

For PCB build process 20, metal stencils can be made of different metals, non-limiting examples of which include stainless steel, copper, bronze or nickel. These metal stencils can be made by a number of methods, non-limiting examples of which include etching, electroforming and laser cutting. The apertures in both laser-cut and electroformed stencils have very sharp edges and are slightly conic. This makes the solder paste easily slip off the aperture edges and thereby secure a uniform print.

For PCB build process 20, it should be understood that solder paste may be applied by any number of methods with any number of apparatus. As a non-limiting example, solder paste may be applied on top of the stencil, then partly rolled and pressed into the stencil apertures and onto the PCB solder lands by a moving an angled squeegee. In this operation, the squeegee angle may be between 45 to 60 degree (usually a selected fixed angle) and the rolling solder paste may have a diameter of 15 to 20 mm. Generally, thin steel squeegees may be used for metal stencils and thick rubber squeegees, as hard squeegees for mesh stencils. It should be noted that rubber squeegees used on stainless steel stencils may wear out quickly and may cause severe scooping in large apertures. Steel squeegees used on mesh stencils may damage the mesh after only a few prints. In many instances, the squeegee printing edge may be sharp to secure a well-defined print.

It should be understood for PCB build process 20, these printing squeegees can have different designs and be made of different materials, non-limiting examples include square rubber rods, thick rubber plates, flat metal plates or other combinations. It is not uncommon to find that commercial operations may use thin metal squeegees for metal stencil printing. For mesh screen printing, it is not uncommon to find that thick rubber plates are used. The squeegees must have a very smooth and none-sticking surface and at all times a sharp printing edge. This will ensure that the solder paste will roll more easily on top of the stencil and help prevent clogging of the stencil apertures.

PCS build process 20 may also incorporate the newest development in solder paste printing, direct printing. This system replaces the squeegees with a printing head that presses the solder paste directly through the stencil apertures using a piston. This type of printing system may not be widespread and is mostly used in high run production because of the large amount of solder paste in use.

While any type of solder may be applied, the embodiments of this application are generally useful where lead-free solder is utilized.

Once the solder paste has been applied, the boards may then proceed to pick-and-place machines, where they are placed on a conveyor belt. Small SMDs may be delivered to the production line on paper or plastic tapes wound on reels. Integrated circuits are typically delivered stacked in static-free plastic tubes or trays. Pick-and-place machines remove the parts from the reels or tubes and place them on the PCB. Second-side components may be placed first, and the adhesive dots are quickly cured with, for example, application of low heat or ultraviolet radiation. The boards are flipped over and first-side components may then be placed by additional pick-and-place machines.

Continuing with PCB build process 20, the boards may then be conveyed into a reflow soldering oven. They may first enter a pre-heat zone, where the temperature of the board and all the components may be gradually and uniformly raised. This helps minimize thermal stresses when the assemblies cool down after soldering. The boards then enter a zone where the temperature is high enough to melt the solder particles in the solder paste, bonding the component leads to the pads on the circuit board. The surface tension of the molten solder helps keep the components in place, and if the solder pad geometries are correctly designed, surface tension automatically aligns the components on their pads.

There are a number of techniques for reflowing solder, any of which may be utilized. As a non-limiting example, in the infrared reflow technique, infrared lamps are utilized. In another non-limiting example, hot gas may be utilized. A further non-limiting example is the use of special fluorocarbon liquids with high boiling points, in a technique called vapor phase reflow. Other methods may utilize nitrogen gas or nitrogen gas enriched air in a convection oven. Certainly, each method has its advantages and disadvantages. With infrared reflow, the board designer must lay the board out so that short components do not fall into the shadows of tall components. Component location is less restricted if the designer knows that vapor phase reflow or convection soldering will be used in production. The present disclosure may be utilized to update CAD data to overcome or minimize the effect of these disadvantages as they are identified.

Following reflow soldering, certain irregular or heat-sensitive components may be installed and soldered by hand, or in large scale automation, by focused infrared beam (FIB) equipment.

Continuing with PCB build process 20, after soldering, the boards may be washed to remove flux residue and any stray solder balls that could short out closely spaced component leads. Rosin flux may be removed with fluorocarbon solvents, high flash point hydrocarbon solvents, or limonene, derived from orange peels. Water soluble fluxes may be removed with deionized water and detergent, followed by an air blast to quickly remove residual water. When aesthetics are unimportant and the flux does not cause shorting or corrosion, flux residues may be left on the boards, saving the cost of cleaning and eliminating the waste disposal. Finally, the boards may be subject to an inspection to find missing or misaligned components and solder bridging. If needed, they may be sent to a rework station for correction of any errors.

Once the printed circuit board has been built, it may then be subjected to qualification step 30. Qualification may be carried out on one board, or to obtain more consistent statistical results, testing in qualification step 30 may be conducted on a batch of boards manufactured under the same conditions. Any type of test may be employed as desired to qualify the printed circuit board. It should be understood that the type of test and the method of the testing employed is not the focus of this disclosure, but rather it is the back annotating of the CAD data 10 utilized in the manufacture of the printed circuit board. While the type and extent of testing employed may vary from manufacturer to manufacturer, and may be implemented at the whim of the manufacturer, as a non-limiting example, it is not uncommon to verify component to pad bonding in some manner, for example via accelerated life tests. It should be noted that what constitutes qualification, that is, the meeting of qualification standards, will vary from manufacturer to manufacturer, and such qualification standards are generally determined by each manufacturer, its customers, or set by a third party standard.

Should a printed circuit board or batch of boards fail qualification step 30, the manufacturer may change any number of manufacturing parameters in an effort to optimize the PCB build process 20. These changes may result in back annotation of the electronic data to update CAD data 10. A subsequent board or subsequent batch of boards is then produced in PCS build process 20 with implementation of the changed parameters, which subsequent board is then subject to qualification, and the data updated. The method of this disclosure includes iterating through the steps of building a subsequent board with the updated data, determining if the subsequent board meets qualification, and updating the data until the board meets qualification standards.

It is not uncommon for the cycle between PCB build process 20 and qualification step 30 to be an extensive and expensive process taking many months until qualification is achieved. Consequently, the knowledge learned in optimizing PCB build process 20 may have been obtained at considerable cost and time, and thus is valuable. According to embodiments of the present disclosure, changes implemented into the manufacturing process during optimization may then be propagated made back by updating the CAD data 10, such that future spins have an improved chance of obtaining acceptable quality product.

The cycle between PCB build process 20, qualification 30, and updating of CAD data 10, continues until the printed circuit board passes qualification, at which point there is an update of Part Libraries 40, and a final update of CAD data 10. If desired, Part Library may also be updated during the cycle between PCB build process 20 and qualification 30.

It should be understood that any type of data, may be selected to be back annotated as desired to form updated electronic data, and decisions regarding which data to back annotate may vary from manufacture to manufacturer. Non-limiting examples of such data that may be back annotated includes, but is not limited to data relating to: solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish. Additionally, specific component data could be captured in the CAD Part Library to allow for quick validations. Such data would be captured from component vendors and would convey reliability limits for max peak temperature, max TAL, and max temperature ramp rates.

Upon successful qualification and update of Part Libraries 40 and CAD data 10, Full Production step 50 may then be undertaken utilizing the updated Part Libraries 40 and CAD data 10.

In non-limiting embodiments, part or all of the data structures described or implied herein may be stored on one or more computer readable media or transmitted in a propagated signal.

In further non-limiting embodiments, one or more or all of the steps of any the methods described herein may be described as instructions for execution by an information handling system, and stored on one or more computer readable media or transmitted by a propagated signal.

In even further embodiments, information handling systems are invisioned which include computer readable comprising the above described data structures or instructions.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

What is claimed is:

1. Method of updating electronic data utilized in the manufacture of a printed circuit board assembly, the method comprising:
A. Determining whether the board meets qualification standards; and
B. Updating the electronic data based on the qualification standards to optimize the manufacture of the printed circuit board.

2. The method of claim 1 wherein, the electronic data comprises at least one selected from the group consisting of solder stencil solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

3. The method of claim 1, wherein the electronic data is configured as a computer aided design file.

4. The method of claim 3, wherein the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

5. The method of claim 1, further comprising:
C. Making a subsequent assembly utilizing the updated data; and
D. Iterating steps A, B, and C in sequence, until the subsequent assembly meets qualification standards.

6. The method of claim 5 wherein, the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL failing temperature ramp rate data, component moisture sensitivity level (MSL), heat resistance (HR), solder paste composition, and the PCB surface finish.

7. The method of claim 5, wherein the electronic data is configured as a computer aided design file.

8. The method of claim 7, wherein the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

9. The method of claim 5, wherein the electronic data are configured as a computer aided design file and a part library file, the method further comprising:
E. Updating the computer aided design file and the part library file.

10. The method of claim 9 wherein, the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

11. Method of qualifying a printed circuit board assembly, the method comprising:
A. Manufacturing a printed circuit board assembly utilizing electronic data;
B. Determining whether the assembly meets qualification standards;
C. Updating the electronic data based on the qualification standards to optimize the manufacture of the assembly;
D. Manufacturing a subsequent assembly utilizing the updated data; and
E. Iterating steps B, C and D in sequence, until the subsequent assembly meets qualification standards.

12. The method of claim 11 wherein, the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

13. The method of claim 11, wherein the electronic data is configured as a computer aided design file.

14. The method of claim 13, wherein, the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL falling temperature ramp rate data, component moisture sensitivity level (MSL), heat resistance (HR), solder paste composition, and the PCB surface finish.

15. The method of claim 11, wherein the electronic data are configured as a computer aided design file and a part library file, the method further comprising:
F. Updating the computer aided design file and the part library file.

16. The method of claim 15 wherein, the electronic data comprises at least one selected from the group consisting of solder stencil geometry data, preheat temperature data, preheat time data, time above liquidous (TAL) data, peak temperature data, pre-heat rising ramp rate data, TAL rising ramp rate data, TAL failing temperature ramp rate data, component moisture sensitivity level (MSL), heat resistance (HR), solder paste composition, and the PCB surface finish.

17. A computer readable medium having stored thereon a data structure comprising electronic data obtained from a printed circuit board qualification process, the printed circuit board comprising a number of components of interest, the data structure operable as a computer aided design file for use in the manufacture of subsequent printed circuit boards, the data structure comprising:
a component data field for each component of interest comprising data identifying that component; and
associated with each component data field at least one of the following data fields:
a first data field comprising solder stencil geometry data;
a second data field comprising preheat temperature data;
a third data field comprising preheat time data;
a fourth data field comprising time above liquidous (TAL) data;
a fifth data field comprising peak temperature data;
a sixth data field comprising pre-heat rising ramp rate data;
a seventh data field comprising TAL rising ramp rate data;
an eighth data field comprising TAL falling temperature ramp rate data;
a ninth data field comprising moisture sensitivity level;
a tenth data field comprising heat resistance;
a eleventh data field comprising solder paste composition; and,
a twelfth data field comprising PCB surface finish.

18. The medium of claim 17 wherein the electronic data is configured as a computer aided design file and a part library file.

19. The medium of claim 17 wherein the electronic data is configured as a computer aided design file.
